(19) United States
(12) Patent Application Publication
(10) Pub. No.: US 2025/0114967 A1
(43) Pub. Date: Apr. 10, 2025

(54) MULTI-FUNCTIONAL ENGINEERED COMPOSITE PANEL WITH LIGNOCELLULOSIC STRANDS AND ANTI-SETTLING FIBERS

(71) Applicant: LOUISIANA-PACIFIC CORPORATION, NASHVILLE, TN (US)

(72) Inventors: QINING SUN, FRANKLIN, TN (US); CHRISTINA M. YOUNGERS, NASHVILLE, TN (US); MINA ESKANDER, NOLENSVILLE, TN (US); KEITH T. QUISENBERRY, WHITE HOUSE, TN (US); RYLIE BARLING, NASHVILLE, TN (US); ANDREW DAY, NASHVILLE, TN (US); ADAM J. STUBBS, ASHLAND CITY, TN (US)

(21) Appl. No.: 18/798,082

(22) Filed: Aug. 8, 2024

Related U.S. Application Data
(60) Provisional application No. 63/543,112, filed on Oct. 9, 2023.
(60) Provisional application No. 63/652,324, filed on May 28, 2024.

(51) Int. Cl. B27N 3/14; B27N 3/12

(52) U.S. Cl. CPC B27N 3/143; B27N 3/12

(57) ABSTRACT

A multi-layer engineered-wood composite panel or board with a core strand layer, with one or both top and bottom surface layers formed with “fluffy” fiber layers. The fibers may be synthetic or natural. The fibers have anti-settling characteristics. The fibers may be micro-fibrillated cellulose and subsequent cellulose elemental fibrils processed to reduce lignocellulosic recalcitrance and allow the structural integrity of cell walls to be loosened and fibers to be unfolded and exposed. The processed fibers when used as a surface layer provide a denser, smoother and more uniform surface than that obtained with particle-based products.

This application claims benefit of and priority to U.S. Provisional Applications No. 63/543,112, filed Oct. 9, 2023, and No. 63/652,324, filed May 28, 2024, both of which are incorporated herein in their entireties by specific reference for all purposes.

### FIELD OF INVENTION

This invention relates to an engineered-wood composite panel or board comprising lignocellulosic strands with surface anti-settling fibers.

### BACKGROUND OF INVENTION

Most lignocellulosic composites used for furniture manufacturing and interior decorative design of living spaces are unable to deliver strong mechanical strength with a paintable and smooth surface able to accept overlay materials. The surface quality of laminated wood-based panels is determined by the size of the wood particles, strands, or fibers on the surface layer. Any surface irregularities on the substrate may show through the overlay and influence the quality of final products. This well-known “telegraphic effect” is due to the roughness of the substrate penetrating through the overlay. When exposed to high humidity over time, the surface roughness of these panels is exacerbated.

Accordingly, what is needed is a wood-based or engineered wood composite panel with strong mechanical strength with a smooth surface free or substantially free of irregularities.

### BRIEF DESCRIPTION OF THE DRAWINGS

FIG. 1 shows an illustration of the formation of a 3-layer fiber-strand panel in accordance with the present invention.

FIG. 2 shows a perspective cutaway view of a pre-press 3-layer fiber and strand matrix mat layout.

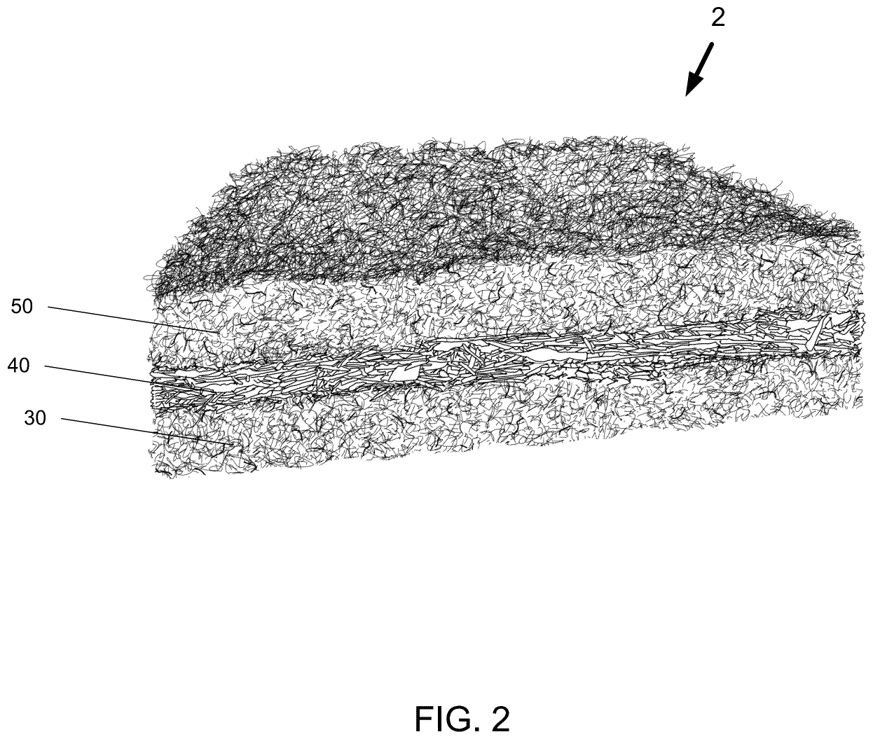

FIG. 3 shows a cross-section of a 3-layer fiber/strand/fiber panel composite (after press) in accordance with the present invention.

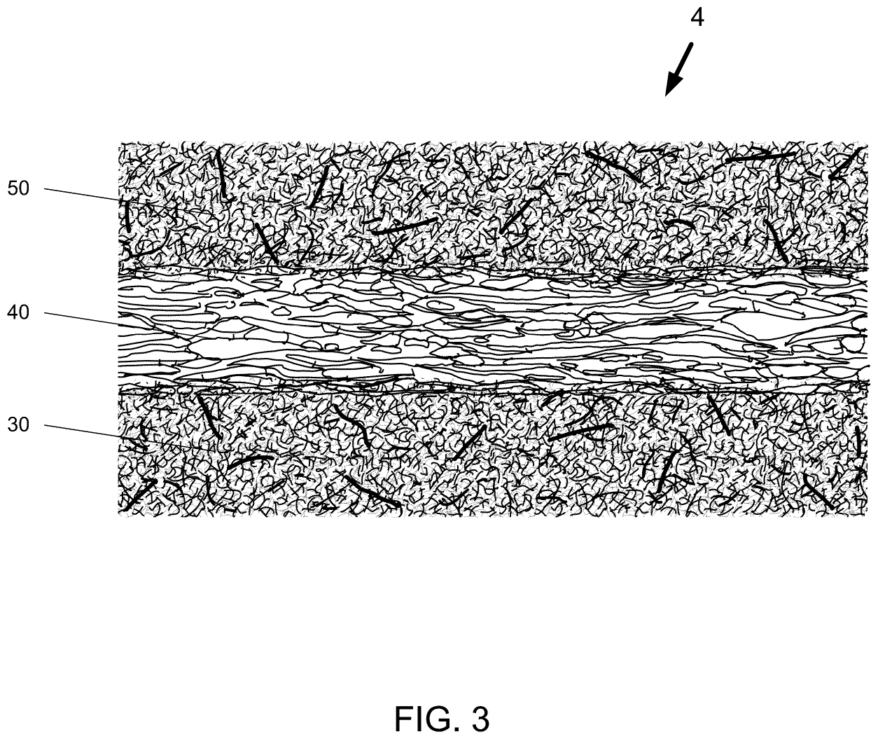

FIG. 4 shows a perspective cutaway view of a pre-press 2-layer fiber and strand matrix mat layout.

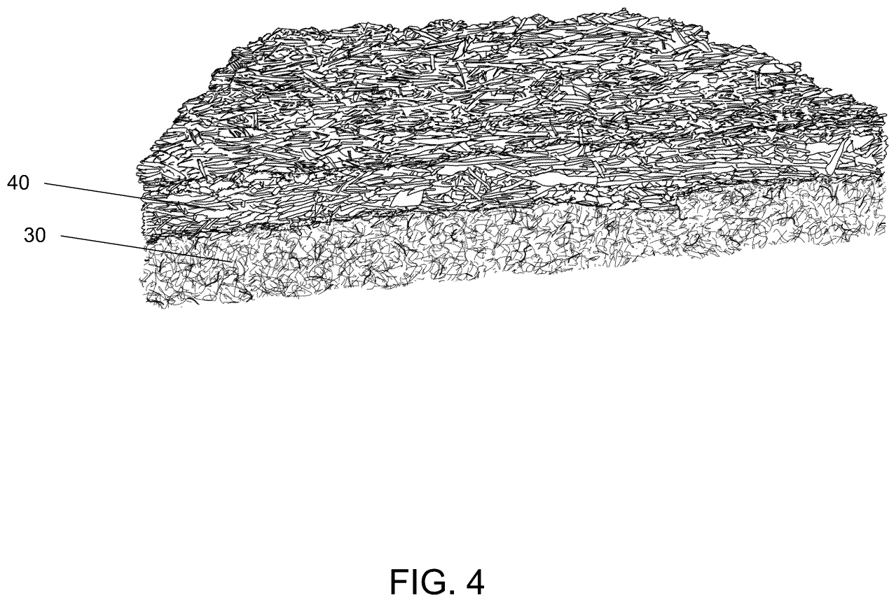

FIG. 5 shows a cross-section of a 2-layer fiber/strand panel composite (after press) in accordance with the present invention.

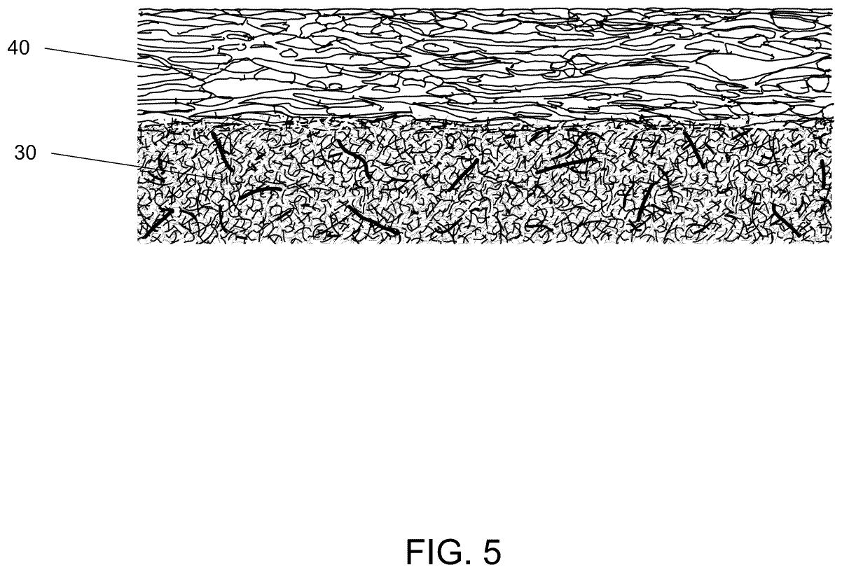

FIG. 6 shows a cross-section of a 3-layer fiber/strand/fiber panel composite (after press) where the fiber layers have different thicknesses.

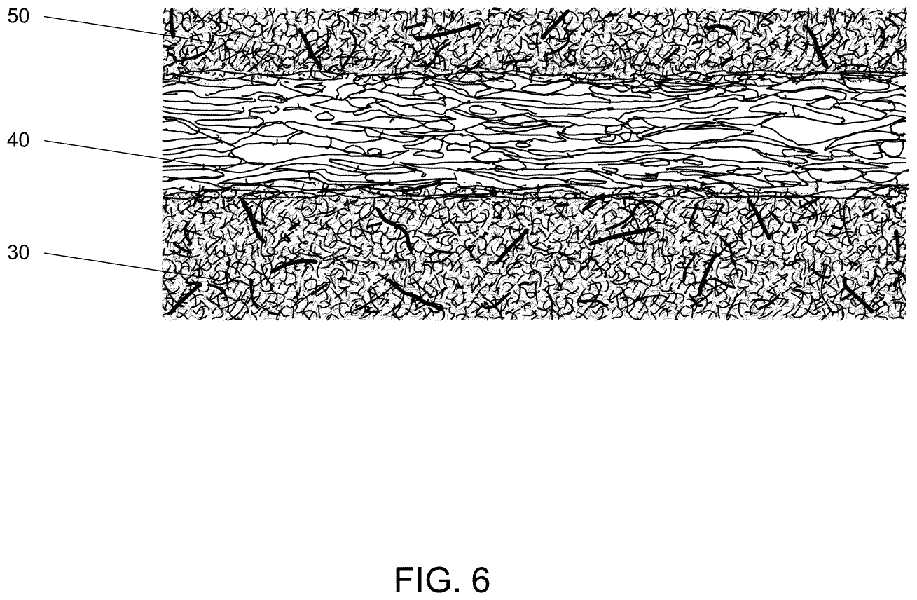

FIG. 7 show the panel of FIG. 3 with an overlay layer.

FIG. 8 shows the panel of FIG. 3 with a printed surface/ink layer.

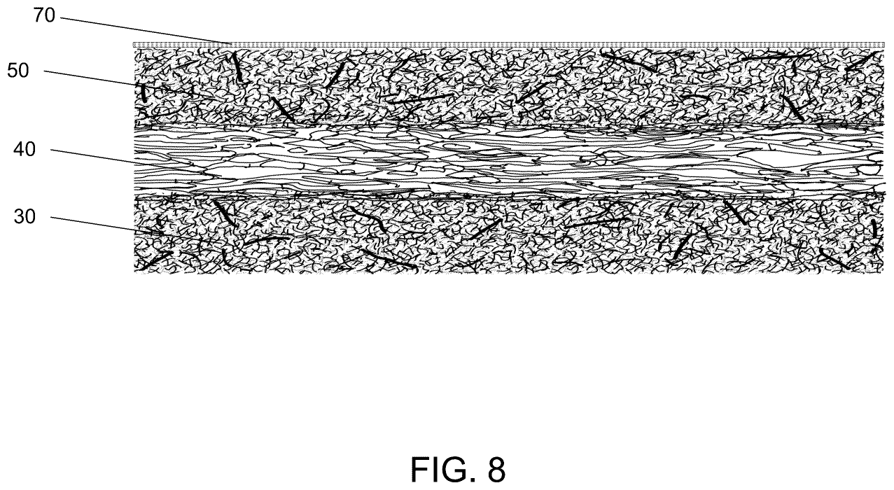

FIG. 9 shows a cross-section of a 3-layer fiber/strand/fiber panel composite, where the core strand layer comprises three oriented strand layers.

### BRIEF DESCRIPTION OF INVENTION

In various exemplary embodiments, the present invention comprises an engineered-wood composite panel or board 4 comprising lignocellulosic strands with anti-settling fibers disposed in one or both surface layers 30, 50. The lignocellulosic strand core matrix 40 may comprise either randomly oriented strands or a multiple cross-ply oriented strand construction.

Anti-settling in this context refers to the resistance of a fiber or similar material from settling to the bottom of a layer, mixture, or structure over time. For example, the lofted, interlocking fibers of the present invention resist settling or slumping to the bottom of a layer. These characteristics help ensure a consistent distribution of fibers or similar material in a layer, structure or mixture.

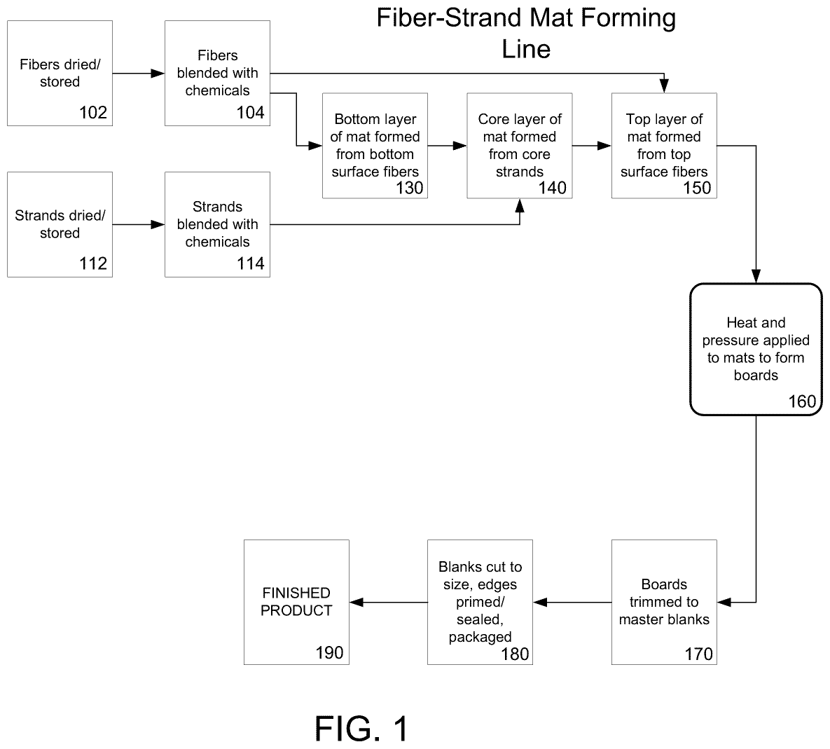

As seen in FIG. 1, the unique fiber-strand composite 4 may be produced by batch presses (cycle presses) of either single or multi-opening design, or continuous presses at elevated temperatures and high pressure. Strands are dried and stored 112, as are fibers 102. Fibers to be used for formation of one or more layers of the mat 2 may be blended with chemicals as described below 104. Similarly, strands to be used for formation of one or more layers of the mat 2 may be blended with chemicals as described below 114. For a three-layer panel, a three-layer mat is formed. While FIG. 1 shows the steps for a three-layer mat, the mat may be two layers, or more than three layers, with each layer being formed sequential on the mat forming line.

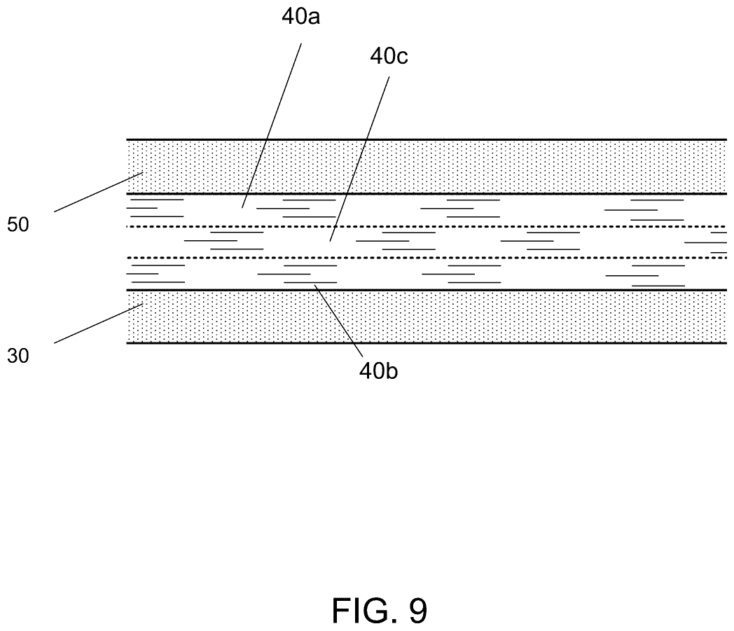

In the three-layer embodiment shown, a bottom mat layer is formed from fibers intended for use on the bottom surface 130, a core matrix layer is formed from core strands 140 on top of the bottom mat layer, and then a top mat layer is formed from fibers intended for use on the top surface 150. In several embodiments, the core matrix layer itself may be multilayer, and formed from two, three or more strand layers (e.g., a top strand layer 40a, a center or core strand layer 40c, and a bottom strand layer 40b), as seen in FIG. 9.

The mat is then inserted in the press and subjected to heat and pressure to form a “board” 160. The board may be trimmed to form a master blank 170. The board or master blank may then be cut to panels of various size, with or without edges primed and/or sealed, and packaged 180 to form the finished panel composite product 190.

As seen in the figures, the present invention combines a lignocellulosic strand core matrix 40 with at least one “fluffy” fiber surface layer 30, 50. The fibers may be synthetic fibers (e.g., polyester, rayon, nylon, spandex, acrylic fibers, carbon fibers, and the like) and/or natural fibers (e.g., from plant, animal, or mineral sources, such as, but not limited to, chitosan fibers from crab shells, lignocellulosic fibers from wood and/or herbaceous plants, and the like). Functional groups may be attached to the fibers. Functional groups (including, but not limited to, —OH, —NH₃, —NH₂—, —COOH, —CONH—, —CONH₂, —SH, and the like) can form hydrogen bonds (H-bond) and/or covalent bonds with the lignocellulosic strand matrix, thereby creating a strong fiber/matrix interface.

Natural or synthetic fibers applied in this invention possess fluffy, flossy, puffy, loose-fill, anti-settling, whiskers-like characteristics before and after being treated or blended with functional additives, fillers, or materials. Lignocellulosic fibers refer to cellulosic fibers comprising micro-fibrillated cellulose and subsequent cellulose elementary fibrils, which may be obtained from softwood or hardwood (e.g., aspen, eucalyptus, and pines), non-wood (sisal, green coconut, yam, bamboo, fique, hemp, flax, jute, curauá, and ramie), cellulose microfibrils, cellulose nanocrystals, cellulose nano-whiskers, and the like. Fibers obtained from lignocellulosic biomass are subjected to preheating and refining (e.g., attrition milling) with pressurized steam, defibration via mechanical or chemical pulping methods, drying and blending with functional additives/fillers, to reduce lignocellulosic recalcitrance and allow the structural integrity of cell walls to be loosened and fibers to be unfolded and exposed.

The length of fiber in the present invention is 20 millimeters (mm) or less, preferably 4 mm or less, and most preferably 1 mm or less. Fiber width (or diameter) is 1000 micrometers (μm) or less, preferably 200 μm or less, and most preferably 55 μm or less. These size ranges, in combination with the other features discussed herein, help the resulting composite to achieve the denser, smoother, and more uniform surface characteristics that facilitate both the lamination of various overlay materials and the acceptance of different coatings and adhesives.

Strand species used in the core matrix layer 40 may include hardwoods and/or softwoods, with aspen and/or southern yellow pine commonly used. Alternate wood species (e.g., basswood, poplar, eucalyptus, birch, soft maple, pine) may also be blended into primary wood species for the composite. In alternative embodiments, lignocellulosic biomass (i.e., herbaceous and/or woody plants) may comprise the core material. The slenderness ratio (length to thickness) of lignocellulosic strands or flakes may range from 50 to 2000, more preferably from 120 to 400 for decorative panels. The width of strands may range from 5 mm to 100 mm, more preferably from 20 mm to 60 mm. The length of strands may range from 25 mm to 230 mm, preferably 110 mm to 190 mm. The thickness of strands may range from 0.1 mm to 5.0 mm, preferably 0.3 mm to 1.0 mm.

The core matrix 40 comprises lignocellulosic strands that have been pre-coated by resin, wax and/or other additives 104. The strands may be randomly oriented or with a multiple cross-ply construction, as seen in the figures. Both outer layers (front face and back face, or backer) comprise native or synthetic fibers that have been pre-coated by resin, wax or other additives 114. A mat is formed by sequentially laying the bottom surface material, core material, and top surface material as a mat structure on a production line 130, 140, 150. Where the core material itself comprises multiple layers, those layers are sequential laid from bottom to top as well in their turn. The mat structure formed generally is linearly continuous, and is subsequently segmented and processed through the pressing cycle 160 for the application of heat and pressure.

The core matrix 40 (as part of the mat) is pressed to a density between 10 and 55 pounds per cubic feet (pcf), with a thickness ranging from 1.0 mm to 30.0 mm. For decorative panels, the density range preferably is 20 to 42 pcf, more preferably 20 to 30 pcf, and most preferably 20 to 25 pcf.

The outer layers (as part of the mat) are pressed to a density between 10 to 80 pcf, preferably 35 to 65 pcf. The thickness of each of the outer layers may range from 0.1 to 20 mm, more preferably 0.5 to 3.5 mm. Before being formed on the mat, fibers are either kept in their dry and fluffy state, or pre-formed into a separate fiber mat. They are coated with resin, wax, and/or functional additives, and are positioned both underneath and on top of the core strand matrix layer for the subsequent hot-pressing process. All coated fibers could also be positioned either on top of the strand layer or beneath the strand layer, forming a two-layer mat (and panel).

The finished fiber-strand composite after pressing has a density ranging from 10 to 60 pcf, preferably 20 to 50 pcf for decorative panels.

In several embodiments, the fiber-strand composite formulation utilizes resin loading (based on 100% solids) from 0.1% to 40.0%, preferably 2.0% to 10.0%, (w/w) based on oven-dry weight of strands and fibers. Resin may comprise amino resins such as urea-formaldehyde (UF) resin or melamine fortified urea formaldehyde resin (MUF), phenolic resins such as phenol formaldehyde resin (PF) or resorcinol-formaldehyde resin, alkali silicates, adhesion promoters such as silane coupling agents, a blend of amino resin and polymeric methylene diphenyl diisocyanate (pMDI) resin, or 100% pMDI resin. In one exemplary embodiment, the resin comprises 100% pMDI resin.

Surface resins and core resins may be the same or different, and surface and core resin levels may be the same or different. In one exemplary embodiment, 8% resin loading of pMDI is used and referenced as resin weight relative to weight of core matrix strands (8% pMDI resin=8 lbs pMDI resin per 100 lbs of dry wood strands, % resin/% strand (w/w)), along with 5% resin loading of pMDI relative to oven-dry weight of surface fibers.

The moisture content of lignocellulosic strands and fibers may range from 3.0 to 30.0%, preferably 8.0 to 12.0%.

The above-described size, density, thickness, moisture content, and resin-loading formulations of the referenced fiber and/or strand layers, in combination with the other features discussed herein, ensure that the resulting composite achieves and provides the denser, smoother, and more uniform surface characteristics that facilitate both the lamination of various overlay materials and the acceptance of different coatings and adhesives, as well as the strength of the resulting product, along with the overall strength of the product, including utilizing the superior strength of the OSB strand core.

Additives and/or fillers may be blended into the fibers and strands, and include, but are not limited to, lignocellulosic (e.g., wood) fines, lignocellulosic (e.g., wood) flour, lignocellulosic (e.g., wood) powder, lignins (e.g., kraft lignin, lignosulfonate, organosolv lignin, soda lignin), inorganic and organic colorants and pigments, insecticides, preservatives (e.g., boron compounds, borax, boric acid, disodium octaborate tetrahydrate (DOT), zinc borates, and the like), flame retardants (e.g., zinc oxide, aluminum hydroxide, zinc borate, boric acid, ammonium borate, odium tetraborate, aluminum hydroxide, aluminum trihydrate, magnesium hydroxide, ammonium polyphosphate, ammonium dihydrogen phosphate, diammonium phosphate, ammonium sulfate, ammonium carbonate, urea, melamine, dimelamine phosphate, guanidine phosphate, or mixtures thereof), anti-microbial agents, moisture-resistant materials (e.g., paraffin wax or tallow wax, bio-wax from lignocellulosic extractives such as pine chemicals), UV stabilizers, reinforcing fillers, humectants, and other additives known in the art. In one exemplary embodiment, fibers and strands are pre-coated with pMDI resin and paraffin wax emulsion, and then blended with wood fines or micro-particles, and functional pigments (ACEMATT® 3300/3400/3600), and zinc borate or boric acids, before mat formation.

While Lightweight Strand Board (LSB) and Fine OSB have been developed using microparticles (commonly used in particleboard) in combination with strands, the fiber-using engineered-wood composite of the present invention possesses several aspects that distinguish it from particle-based products. The physical configuration of the lignocellulosic elements gives the fiber-based layer or layers unique surface characteristics, as discussed herein. Since lignocellulosic biomass is fibrous by nature, the fiber layer retains and exploits the inherent strength of the biomass to a greater extent than do particle-based boards. Fibers from lignocellulosic, or any other sources, are usually smaller than particles and fines, in one or more dimensions, and result in a denser, smoother, more uniform surface that facilitates both the lamination of various overlay materials and the acceptance of different coatings and adhesives, all the while utilizing the superior strength of the OSB strand core.

Accordingly, the engineered-wood composite of the present invention possesses improved properties compared to prior-art OSB (oriented strand board) and/or fiberboards and/or particleboards, including, but not limited to, the following:
stronger holding power with screws and fasteners on the faces and edges as compared to traditional particleboard or MDF substrates, due to the OSB strand core interlocking with fiber layers.
stronger mechanical strength, i.e., IB, MOR, MOE (internal bonding, modulus of rupture, modulus of elasticity) as compared to traditional particleboard or MDF.
lighter weight as compared to traditional fiberboards, such as MDF.
improved dimensional stability as compared to traditional phenolic resin or amino resin coated OSB (i.e., less % change in transverse or longitudinal direction when subjected to changes in temperature (thermal) or relative humidity (hygroscopic)).
improved thickness tolerance (i.e., variation from nominal) as compared to traditional OSB.
improved surface paintability as compared to traditional particleboard or OSB.
improved telegraphing resistance resulting from laying “fluffy” fibers onto the strand matrix to form denser and uniform fiberboard-like surface layers vs. traditional OSB and related fine and/or micro-particle embedded OSB products.
increased surface flatness, uniformity, smoothness, and paintability (compared to traditional OSB and particle board) to facilitate laminating various overlay materials for different applications, e.g., furniture and kitchens, wall paneling, door, shipyards and automotive applications, and the like.
improved surface pattern embossing or engraving compared to decorative products made from wood fines or micro-particles with core strands.

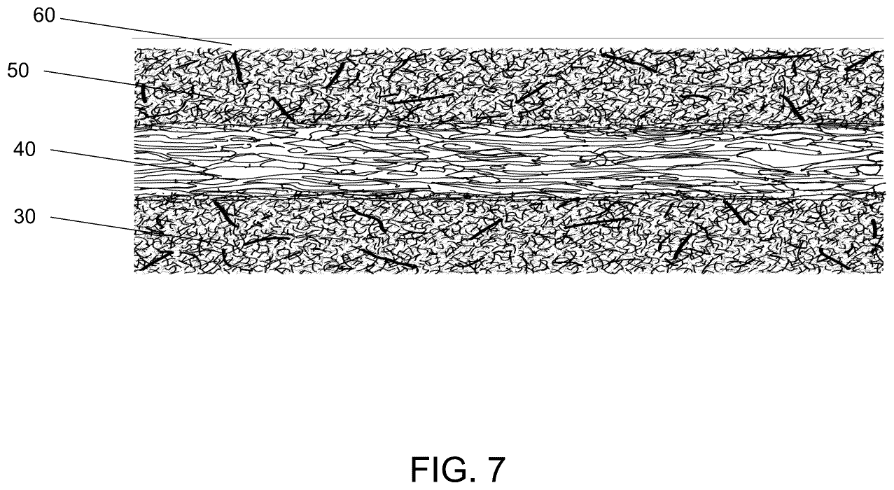

As seen in FIG. 7, the panel may be faced on one or both surfaces with various overlay materials 60, including, but not limited to, natural wood veneers, high-pressure laminates, low-pressure laminates, melamine sheets, light basis weight papers, thermally fused papers, metal foils, vinyl films, and the like. The panel may be coated with a waterborne, solvent-based, or powder coating using well-established application methods, including but not limited to, dip coating, spraying, brushing, roll coating, spin coating, flow/curtain coating, and similar techniques.

Due to the improved surface and paintability of the panel fascia apportioned by fluffy fibers, one or both faces can also be decorated or have material printed thereon 70 using digital printing technology.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method for producing a wood-based composite panel, comprising the steps of:
forming a composite mat on a production line in a factory by
forming a bottom fiber layer with a first set of processed fibers, wherein the first set of processed fibers comprises anti-settling fibers;
forming, on top of the bottom fiber layer, a core strand layer with a plurality of wood strands;
forming, on top of the core strand layer, a top fiber layer with a second set of processed fibers, wherein the second set of processed fibers comprises anti-settling fibers;
and
applying pressure and heat by a press to the composite to form a wood-based composite board with fiber-based surface layers.

2. The method of claim 1, wherein the first set of processed fibers comprise synthetic fibers.

3. The method of claim 1, wherein the first set of processed fibers comprise natural fibers.

4. The method of claim 1, wherein the first set of processed fibers comprise synthetic fibers.

5. The method of claim 1, wherein the first set of processed fibers comprise natural fibers.

6. The method of claim 1, wherein processed fibers in the first set of processed fibers and the second set of processed fibers are the same.

7. The method of claim 1, wherein the core strand layer comprises multiple sub-layers of oriented strands.

8. The method of claim 1, wherein one or more functional groups are attached to the processed fibers in the first set of processed fibers and/or the second set of processed fibers.

9. The method of claim 1, wherein the processed fibers in the first set of processed fibers and/or the second set of processed fibers are treated or blended with one or more functional additives or fillers prior to mat formation.

10. The method of claim 1, wherein strands are treated or blended with one or more functional additives or fillers prior to mat formation.

11. The method of claim 1, wherein the processed fibers in the first set of processed fibers and/or the second set of processed fibers are 4 mm or less in length, with a width or diameter of 200 μm or less.

12. The method of claim 1, wherein the processed fibers in the first set of processed fibers and/or the second set of processed fibers are 1 mm or less in length, with a width or diameter of 55 μm or less.

13. A wood-based composite panel, comprising:
a bottom fiber layer with a first set of processed fibers, wherein the first set of processed fibers comprises anti-settling fibers;
a core strand layer with a plurality of wood strands overlaying and integrated with the bottom fiber layer; and
a top fiber layer with a second set of processed fibers overlaying and integrated with the core strand layer, wherein the second set of processed fibers comprises anti-settling fibers.

14. The composite panel of claim 13, wherein the first set of processed fibers comprise synthetic fibers.

15. The composite panel of claim 13, wherein the first set of processed fibers comprise natural fibers.

16. The composite panel of claim 13, wherein the first set of processed fibers comprise synthetic fibers.

17. The composite panel of claim 13, wherein the first set of processed fibers comprise natural fibers.

18. The composite panel of claim 13, wherein the core strand layer comprises multiple sub-layers of oriented strands.

19. The composite panel of claim 13, wherein one or more functional groups are attached to the processed fibers in the first set of processed fibers and/or the second set of processed fibers.

20. The composite panel of claim 13, wherein the processed fibers in the first set of processed fibers and/or the second set of processed fibers are treated or blended with one or more functional additives or fillers.
